(19) United States
(12) Patent Application Publication
(10) Pub. No.: US 2026/0346705 A1
(43) Pub. Date: Nov. 5, 2026

(54) TANK FOR A VEHICLE

(71) Applicant: AMPERE S.A.S., Boulogne Billancourt (FR)

(72) Inventor: Panagiotis CHRISTOU, Guyancourt (FR)

(73) Assignee: AMPERE S.A.S., Boulogne Billancourt (FR)

(21) Appl. No.: 19/141,906

(22) PCT Filed: Dec. 19, 2023
(86) PCT No.: PCT/EP2023/086639

§ 371 Date: Jun. 20, 2025

(30) Foreign Application Priority Data
Dec. 21, 2022 (FR) FR2214047

(51) Int. Cl. B60K 15/063; B60K 15/03; B60K 15/073; B62D 21/16; F17C 1/00; F17C 13/08

(52) U.S. Cl. CPC B60K 15/063; B60K 15/073; B62D 21/16; F17C 1/00; F17C 13/084; B60K 2015/03315; F17C 2201/0157; F17C 2205/0107; F17C 2221/012; F17C 2223/036

(57) ABSTRACT

A tank is for a vehicle. The tank is intended to store an energy fluid. The tank forms a structural part of the vehicle.

### TECHNICAL FIELD OF THE INVENTION

The invention relates to a tank for a vehicle, the tank being intended to store an energy fluid, particularly hydrogen. The invention also relates to a chassis for a vehicle comprising such a tank. The invention further relates to a vehicle, particularly a motor vehicle, comprising such a tank and/or such a chassis.

### PRIOR ART

In order to make the use of vehicles less polluting, there are known vehicles which are fitted with a fuel cell which is supplied with energy by hydrogen. Therefore, these vehicles have on-board a tank, in which hydrogen is stored before being consumed by the fuel cell. The pressure of the hydrogen in these tanks may be very great, for example, in the order of 700 bar. The tanks must therefore be particularly resistant to the mechanical stresses which are applied by the pressurized hydrogen. Furthermore, hydrogen is a highly flammable gas which involves risks of fire in the event of leaks. The hydrogen tanks must therefore also be resistant to impacts so as to ensure the safety of passengers in the event of an accident of the vehicle.

The tanks known from the prior art are generally in the form of one or more cylinders which are mounted on-board the vehicle, for example, cylinders positioned under seats of the vehicle. These tanks are very heavy and therefore cause the total weight of the vehicle to increase, which is counter to the objective of providing a more economical vehicle in terms of energy. Furthermore, the tanks are also very bulky and their integration in a vehicle impairs the volume available for the passengers or for storing objects. Finally, these tanks are also complex to fix in a reliable and stable manner within the vehicle.

### STATEMENT OF THE INVENTION

The object of the invention is to provide a tank for a vehicle which overcomes the disadvantages above and which improves the known tanks of the prior art.

More specifically, a first object of the invention is to provide a vehicle which is provided with a tank which is intended to store an energy fluid, such as hydrogen, which is relatively lightweight, simple to assemble and which allows a relatively large volume to be conserved for passengers or for storage.

### DESCRIPTION OF THE INVENTION

The invention relates to a tank for a vehicle, the tank being intended to store an energy fluid, the tank forming a structural element of the vehicle. The tank may comprise at least a first pair of opposite walls which are connected to each other by a first assembly of hollow connection elements which pass through the tank and which extend parallel with a first axis.

The tank may comprise at least a second pair of opposite walls which are connected to each other by a second assembly of hollow connection elements which pass through the tank and which extend parallel with a second axis, the second axis forming an angle which is not equal to zero with the first axis, in particular the tank comprising at least a third pair of opposite walls which are connected to each other by a third assembly of hollow connection elements which pass through the tank and which extend parallel with a third axis, the third axis forming with the first axis an angle which is not equal to zero and the third axis forming with the second axis an angle which is not equal to zero.

The tank may comprise at least one fixing interface which is arranged at one end of at least one connection element.

The at least one fixing interface may comprise a tapped insert which is intended to cooperate with a fixing screw and/or an insert which is intended to cooperate with a clip.

The tank may comprise a rigid structure which is made of composite material.

The tank may be configured to store an energy fluid, in particular hydrogen, at a pressure which is greater than or equal to 700 bar.

The invention also relates to a chassis for a motor vehicle comprising a tank as defined above.

The chassis may comprise two side bars which extend longitudinally and the tank may be fixed to each of the two side bars in the longitudinal continuation of the two side bars.

The invention also relates to a vehicle, particularly a motor vehicle, comprising a tank as defined above and/or a chassis as defined above.

### DESCRIPTION OF THE FIGURES

These objects, features and advantages of the present invention will be set out in detail in the following description of a specific embodiment which is given by way of non-limiting example with reference to the appended figures, in which:

FIG. 1 shows a schematic profile view of a motor vehicle according to one embodiment of the invention.

FIG. 2 shows a partial, perspective plan view of a chassis of the vehicle.

FIG. 3 shows a side view of a tank of the vehicle, equipment items being fixed to an upper wall of the tank.

FIG. 4 shows a plan view of the tank of FIG. 3.

FIG. 5 shows a partial, perspective bottom view of the chassis of the vehicle.

FIG. 6 shows a perspective bottom view of the tank, the tank being provided with a protection casing.

FIG. 7 shows a longitudinally sectioned, vertical view of the tank.

FIG. 8A shows a partial, perspective view of an embodiment of a tank of the vehicle.

FIG. 8B shows a transparent view of the tank of FIG. 8A.

FIG. 9 shows a sectioned view of a fixing interface of the tank according to a first embodiment.

FIG. 10 shows a sectioned view of a fixing interface of the tank according to a second embodiment.

### DETAILED DESCRIPTION

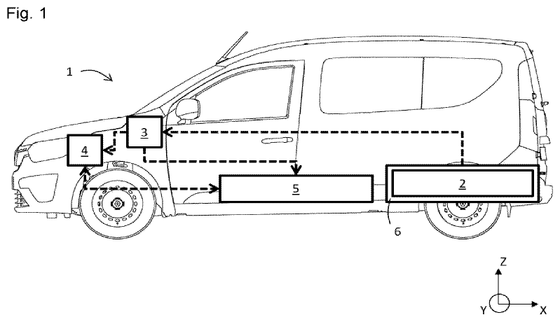

FIG. 1 schematically illustrates a motor vehicle 1 according to an embodiment of the invention. The vehicle 1 may be, for example, a passenger vehicle or a utility vehicle. As a variant, it could be a truck, a bus, a lifting gear, agricultural machinery or even any other type of land vehicle. The invention may particularly be suitable for an aircraft or a boat.

In this document, the axis X denotes the longitudinal axis of the vehicle 1. During forward travel in a straight line, the vehicle 1 progresses from the rear toward the front in a direction parallel with its longitudinal axis. The axis X is orientated from the front toward the rear of the vehicle, that is to say in the direction of backward travel. The axis Y denotes the transverse axis of the vehicle. The axis Y is orientated from the left to the right, the left and right being defined in accordance with the point of view of a driver of the vehicle 1. The axis Z denotes the axis perpendicular to the axis X and to the axis Y. It may be considered that the vehicle 1 is positioned on horizontal underlying ground. The axis Z is a vertical axis which is orientated from the bottom to the top. The axes X, Y and Z form an orthogonal reference system. This reference system defined in relation to the vehicle 1 may be used to describe a tank 2 of the vehicle 1, even considered outside the vehicle because the tank is intended to be integrated in the vehicle according to a specific orientation.

The vehicle 1 is provided with a tank 2 according to one embodiment of the invention. The tank 2 is intended to contain an energy fluid, that is to say a fluid forming a reserve of energy which can be converted into an electromotive force capable of displacing the vehicle. The tank 2 is therefore a member of the vehicle 1 which confers a specific autonomy on it. The tank particularly comprises an inlet opening which allows the tank to be filled with an energy fluid and an outlet opening for supplying then consuming the energy fluid contained in the tank.

According to a preferred embodiment, the tank 2 is intended to store hydrogen or more specifically dihydrogen. The vehicle 1 comprises a fuel cell 3 which is capable of converting hydrogen into an electric current and an electric motor 4 which is supplied with energy by an electric current which is output from the fuel cell 3. The vehicle 1 may also comprise an electrochemical battery 5, for example, of the lithium-ion type. The electrochemical battery 5 can be recharged by an electric current output from the fuel cell 3 and/or by a connection to an electricity distribution network. The electric motor 4 may also be supplied with energy by an electric current output from the electrochemical battery 5. The tank 2 which is associated with the fuel cell 3 can thus act as a way of extending the autonomy of the vehicle when the electrochemical battery 5 has become discharged.

As a variant, the architecture of the vehicle 1 could be different. The vehicle 1 could comprise no electrochemical battery so that the tank 2 constitutes the sole energy source of the vehicle 1. According to another variant, the vehicle could comprise an internal combustion engine which is supplied with energy by hydrogen instead of a fuel cell. According to other variants, the tank 2 could be configured to store other types of energy gas, for example, liquified petroleum gas or natural gas. The tank could even be intended to store a liquid fuel such as petrol, gas oil or ethanol.

The tank 2, which could be referred to as a “storage device”, is intended to store a pressurized energy fluid, that is to say at a pressure which is strictly greater than atmospheric pressure. In this instance, the tank 2 is intended to store the energy fluid, in particular hydrogen, at a pressure greater than or equal to 700 bar. In a variant, the tank 2 could be intended to store the energy fluid at a different pressure, for example, a pressure greater than or equal to 300 bar or 500 bar or 1000 bar, or any other value. The tank 2 thus comprises a rigid structure 6 which is capable of withstanding the forces applied by the pressurized fluid which it contains, that is to say centrifugal forces which act from the interior of the tank 2 and which tend to cause it to explode.

Furthermore, the tank may have a capacity greater than or equal to 50 liters, preferably greater than or equal to 100 liters, or even greater than or equal to 150 liters. A 100-liter tank allows approximately 4 kg of hydrogen to be stored at 700 bar, which confers autonomy in the order of 300 km on a motor vehicle.

The structure 6 of the tank is also capable of withstanding great impacts, in particular impacts which are brought about in the event of an accident of the vehicle 1, without generating any leak of energy fluid toward the exterior. The data relating to accident rates and/or simulations and/or crash tests allow the structure 6 to be sized, in particular the required thicknesses of walls, so that no leak of energy fluid occurs, even for the most violent accidents.

According to the invention, the tank 2, the great resistance of which is necessary for withstanding the high pressures of the energy fluid which it contains and for ensuring the safety of the passengers of the vehicle 1 in the event of an accident, is advantageously exploited in order to form a structural element of the vehicle. The term “structural element” denotes an element of the vehicle which is involved in the overall rigidity of the vehicle. In other words, the tank 2 forms a portion of the body of the vehicle, that is to say a portion of the framework of the vehicle. In particular, the tank 2 forms a portion of the chassis of the vehicle, that is to say a portion of the vehicle capable of supporting the weight applied by other equipment items of the vehicle, such as, for example, the weight applied by at least a portion of the car body of the vehicle. Furthermore, not only does the tank support the weight of specific equipment items, it also provides a support which allows these equipment items to be attached.

In particular, the body of the vehicle 1 would not have sufficient rigidity if it were not fitted with the tank 2. That is to say that the body of the vehicle 1 without the tank 2 would become deformed readily, particularly merely under the weight of the equipment items mounted on-board the vehicle, or in the case of a collision of the vehicle 1, even at very low speed. Therefore, the tank 2 constitutes an element of the body of the vehicle 1 which is indispensable for the rigidity and robustness thereof. The integration of the tank 2 in the body therefore allows a considerable reduction in the quantity of material used to produce the vehicle. As a result of the invention, it is possible to reduce or even dispense with specific metal elements which are conventionally used to configure the body and particularly the chassis of a vehicle.

Therefore, the invention is particularly original in that the tank 2, which was conventionally supported by the body, becomes a constituent element thereof. Furthermore, the invention runs counter to received wisdom according to which a tank should be greatly protected as a result of the inflammable or explosive nature of the energy fluid which it contains. According to this received wisdom, the tank would not have to withstand, under normal conditions of use, any constraint other than the one applied by the energy fluid which it contains.

According to the invention, the tank is capable of withstanding loads which can reach at least one hundred kilograms or even several hundreds of kilograms. These loads may be static loads, such as, for example, the ones which are applied by the weight of the car body of the vehicle and/or the weight of equipment items such as seats of the vehicle and/or the weight of the passengers of the vehicle. These loads can also be dynamic loads, such as the ones which appear in particular situations, such as, for example, in the event of an impact against the vehicle. These different static or dynamic loads can apply compression or shearing forces to the tank. Therefore, these forces are orientated in a different direction from the centrifugal forces applied by the pressurized energy fluid inside the tank. Advantageously, the resistance of the tank necessary for withstanding the pressure applied by the energy fluid which it contains is therefore also used to withstand loads which are applied in different directions.

The equipment items of the vehicle which can be supported by the tank 2 and fixed to the tank particularly include:
equipment items which are intended to be arranged in a passenger compartment of the vehicle, in particular seats on which passengers of the vehicle can sit, and/or
safety devices, such as safety belts,
elements of the car body and/or
an impact absorption device and/or
a wheel set and/or
a protection casing.

More generally, the tank 2 may serve to maintain any member or equipment item mounted on-board the vehicle. In particular, the tank may support any equipment item which is external with respect to a storage system or a distribution system for the energy fluid. The tank can also be used to connect several body elements to each other. Thus, it is also possible to envisage supporting the following on the tank 2 and fixing them to the tank 2: an electrochemical battery which is intended to supply a motive power unit of the vehicle and/or a motive power unit and/or transmission means between a motive power unit and drive wheels and/or wheel motors and/or suspension means.

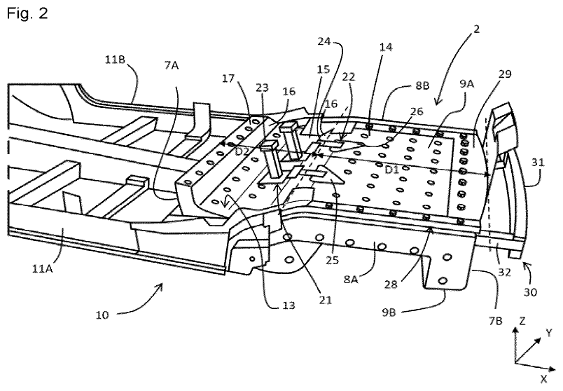

With reference to FIG. 2, the tank 2 may comprise a generally parallelepipedal form. Thus, it may comprise three pairs of opposite walls. A first pair of opposite walls is composed by a front wall 7A and a rear wall 7B. The walls 7A and 7B extend substantially parallel with the axes Y and Z. A second pair of opposite walls is composed of a left side wall 8A and a right side wall 8B. The walls 8A and 8B extend substantially parallel with the axes X and Z. A third pair of opposite walls is composed of an upper wall 9A and a lower wall 9B. The walls 9A and 9B extend substantially parallel with the axes X and Y. In a variant, any other form of the tank could be envisaged.

The tank 2 may be arranged in the rear portion of the vehicle. In particular, the tank may form a rear portion of the chassis 10 of the vehicle, that is to say a rear portion of the substructure of the vehicle. The chassis 10 may comprise two side bars 11A, 11B which extend parallel with the axis X at either side of the vehicle. These two side bars 11A, 11B can extend backward only as far as a location just in front of a rear wheel arch of the vehicle, that is to say that the rear end of the side bars 11A, 11B is positioned in front of the rear wheels of the vehicle. The side bars 11A, 11B can thus be shorter than in a conventional motor vehicle. The tank 2 is fixed directly to each of the two side bars. By connecting the two side bars 11A, 11B to each other, the tank 2 therefore acts as a cross-member of the vehicle. Therefore, the tank 2 allows the two side bars to be fixed rigidly in position relative to each other. The use of the tank 2 therefore allows one or more cross-members in the chassis 10 to be saved. In any case, the vehicle 1 does not comprise any structural cross-member which connects two side bars above or below the tank 2. The vehicle also does not comprise any structural cross-member behind the tank 2 or directly in front of the tank 2.

The tank 2 extends toward the rear of the vehicle 1 in the longitudinal continuation of the two side bars, that is to say that the rear end of the tank 2, in particular the rear wall 7B, is positioned further to the rear than the rear end of the side bars 11A, 11B. The distance D1 along the longitudinal axis between the rear end of the side bars 11A, 11B and a rear edge of the tank 2 may preferably be greater than or equal to 20 cm or greater than or equal to 40 cm or even greater than or equal to 60 cm. The tank 2 can thus extend under a trunk of the vehicle or even as far as the region of a rear fender of the vehicle. The tank can thus be intended to support the load applied by the set of objects stored in the trunk of the vehicle.

In order to ensure good fixing between the side bars 11A, 11B and the tank 2, it is preferable to provide a longitudinal cover between these components, that is to say that a front edge of the tank is positioned further forward than the rear end of the side bars 11A, 11B. Thus, a hinge effect of the interface between the side bars and the tank under the effect of a vertical load or in the event of a longitudinal impact is avoided. The distance D2 along the longitudinal axis between the rear end of the side bars 11A, 11B and the front edge of the tank 2 may preferably be greater than or equal to 10 cm or greater than or equal to 20 cm or greater than or equal to 40 cm. The side bars 11A, 11B preferably do not extend beyond half of the tank 2 along the longitudinal axis X. Each side bar 11A, 11B can be fixed to the two side walls 8A and 8B of the tank, respectively.

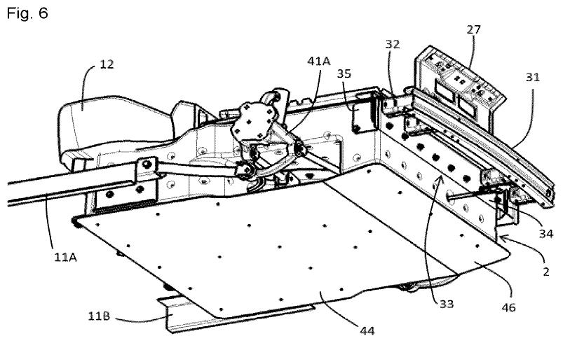

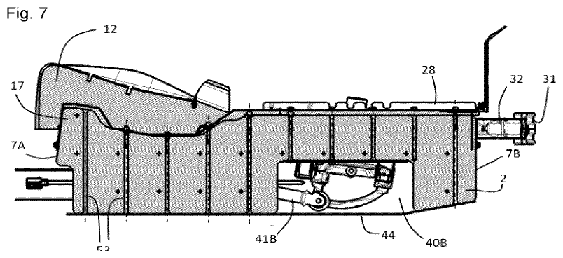

The tank 2 can extend substantially under the base plate of seats 12 of the vehicle 1, in particular the rear seats. The seats 12 (of which the base plate can be seen in FIGS. 6 and 7) can be equally well in the form of individual seats or in the form of a bench type seat on which several persons can sit side by side. The seats 12 can be supported by the tank and fixed to the tank. The seats 12 may be foldable seats and supports for a rotation axle of the backrest of the seats can also be fixed to the tank 2.

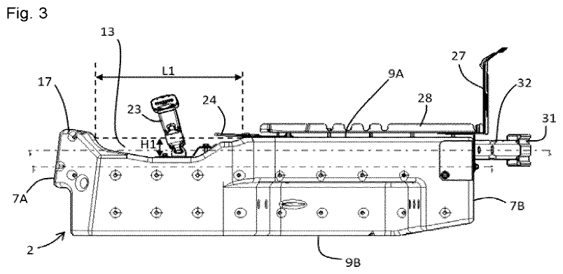

The upper wall 9A may comprise a recess 13 which is intended to receive the base plate of the seats 12 so that the passengers sitting on these seats are not sitting too high. This recess 13 can in particular be clearly seen in FIG. 3. At the rear of the recess 13, the upper wall 9A comprises a horizontal plane 14. The horizontal plane 14 may be intended to form a floor of a trunk. The recess 13 extends at a lower height along the vertical axis Z than the horizontal plane 14 at the rear of the recess.

The recess 13 may have a profiled shape parallel with the transverse axis Y. The recess 13 may comprise a base 15, in particular horizontal base, which is surrounded at the front and rear by inclined walls 16. The recess 13 may have a length L1 along the longitudinal axis X which substantially corresponds to the length of the base plate of the seats 12 along this same axis, or at least 50% of the length of the base plate of the seats 12. This length may, for example, be greater than or equal to 10 cm, preferably greater than or equal to 20 cm. The difference in height H1 along the vertical axis Z, between the base 15 of the recess 13 and the horizontal plane 14 at the rear of the recess may, for example, be greater than or equal to 5 cm, preferably greater than or equal to 10 cm. The height along the axis Z of the horizontal plane 14 at the rear of the recess 13 may be freely selected in accordance with a compromise between the storage space of the trunk and the capacity of the tank. The recess 13 may be arranged in a front half of the upper wall 9A whilst the horizontal plane 14 may be arranged in a rear half of the upper wall 9A.

The chassis 10 does not comprise an additional structural element which is arranged between the tank 2 and the seats 12. The weight and volume occupied by these components can thus be saved. A protection or separation wall may nonetheless be provided between the seats and the tank and/or between the trunk and the tank, in particular in order to improve the appearance and the comfort. However, this wall would not be intended to support the seats or objects which are transported in the trunk and the thickness thereof could be reduced as a result.

Advantageously, the tank 2 also comprises an anti-submarining device 17. Such a device forms a stop which prevents the base plate of the seats 12 from sliding forward in the event of an accident. The anti-submarining device 17 is formed by a projection which extends forward and upward in front of the recess 13. The anti-submarining device 17 may comprise a profiled form along the axis Y and/or extend over the entire width of the tank along the axis Y. As can be clearly seen in FIG. 7, a lower face of the base plate of the seat 12 may comprise a form which complements the form of the anti-submarining device 17. The lower face of the base plate of the seat 12 may therefore comprise a profiled hollow along the axis Y in which the projection of the anti-submarining device 17 is engaged. In addition to improving the safety of the passengers, the integration of the anti-submarining device 17 in the tank 2 enables the volume of the tank to be increased and therefore enables its storage capacity for energy fluid to be increased.

The tank 2 also provides a support for fixing a safety device. The safety device is intended to protect the passengers of the vehicle in the event of an accident. In particular, the safety device may comprise a safety belt and/or a device in accordance with the standard ISO 13216-1:1999, more commonly known as an Isofix system. In particular an anchoring means 21 for a safety belt and/or an anchoring means 22 in accordance with the standard ISO 13216-1:1999 may be fixed to an upper wall 9A of the tank.

The anchoring means 21, 22 may be fixed, for example, welded or screwed, to a plate which is itself screwed against the tank 2.

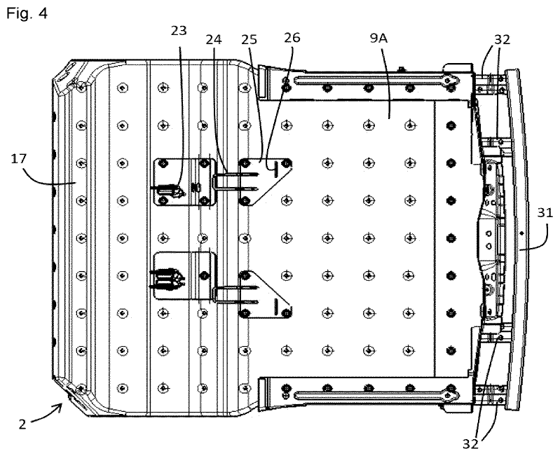

In this manner, the tank 2 is intended to withstand the significant traction forces applied by the anchoring means in the event of an accident. The anchoring means 21 may be connected to a clip-fit device 23 of a safety belt which is also referred to as a stalk. Such a clip-fit device 23 protrudes between the base plate and a back of the seat 12 which is positioned above the tank and it is intended to be activated by a passenger in order to lock or unlock the safety belt. Alternatively, the anchoring means 21 could also be connected to a return device of the safety belt and/or to a winder of the safety belt and/or to a blocking device of the safety belt. As can be clearly seen in FIGS. 3 and 4, the anchoring means 21 may be fixed to the base 15 of the recess 13.

The anchoring means 22 may comprise a curved bar 24 which is in particular made of metal and/or U-shaped. This curved bar 24 is intended to cooperate with a fixing device which is integrated in a removable seat, for example, a child seat, in order to firmly retain this removable seat. The curved bar 24 may extend horizontally perpendicularly to the recess 13. In particular, the curved bar 24 may be welded to a plate 25 which is itself screwed into the tank in the region of a front edge of the horizontal plane 14.

Advantageously, one or more securing hooks 26 for securing luggage may also be fixed to the tank 2. The securing hooks 26 may be fixed against the horizontal plane 14 located at the rear of the recess 13. As can be seen in FIG. 4, a securing hook 26 may where applicable be fixed, in particular welded, to the plate 25 to which the curved bar 24 is welded. Alternatively, the securing hook 26 may be fixed, in particular welded, to a separate plate.

The tank 2 also supports a rear portion of the car body. This rear portion of the car body may comprise, for example, feet which extend substantially vertically as far as a roof of the vehicle and/or rear fins or rear quarter panels and/or a rear portion of a rear door surround of the vehicle and/or a rear door or door of the trunk of the vehicle and a surround of such a rear door. The portion of the car body of the vehicle supported by the tank 2 may be fixed to the tank, in particular in the region of a rear half of the upper wall 9A of the tank. To this end, the chassis 10 comprises a frame 28 which is fixed directly to the tank 2. The frame 28 may itself be fixed directly to a portion of the car body of the vehicle or even constitute a lower edge of the car body. The frame 28 may be arranged on a circumference of the upper wall 9A of the tank. It may generally be U-shaped. The frame 28 may in particular comprise a first segment which extends along a rear edge of the tank 2 and a second and a third segment which extend along the lateral edges of the tank. The frame 28 may be made of metal material and/or be in the form of a corner angle. The frame 28 may in particular comprise a wall 29 which extends against the upper wall 9A of the tank. Said wall 29 may be fixed to the tank by fixing means such as fixing screws. The number and/or the arrangement of the fixing screws may be freely selected in order to obtain the rigidity and the retention desired. In particular, the fixing screws may be distributed in accordance with a regular pitch, for example, a pitch between 5 cm and 30 cm inclusive, in particular between 10 cm and 20 cm inclusive.

A trunk base 27 is fixed directly to the tank 2 or is fixed to the tank 2 via the frame 28. The trunk base 27 comprises a rear wall of the trunk which extends transversely and vertically below the trunk door in a closed position. Means for locking the trunk door, such as, for example, a latch wire may also be fixed to the trunk base 27.

The vehicle 1 further comprises an impact absorption device 30 which is supported by the tank 2 and fixed to the tank 2. In particular, the impact absorption device 30 is fixed exclusively to the tank 2. The impact absorption device 30 is therefore not fixed to the side bars of the vehicle, nor to a metal cross-member.

The impact absorption device 30 is intended to absorb all or part of the kinetic energy transferred to the vehicle 1 in the event of an impact against the impact absorption device 30. The impact absorption device 30 can thus be integrated in a fender of the vehicle. The impact absorption device 30 may be covered with a trim component of the vehicle.

According to the present embodiment, the impact absorption device 30 is arranged in order to withstand the longitudinal impacts on the rear of the vehicle. It is therefore integrated in a rear fender of the vehicle. In a variant, the impact absorption device 30 could be arranged in order to withstand longitudinal impacts on the front of the vehicle and therefore be integrated in a front fender.

When an impact is produced against the impact absorption device 30, a force is automatically transmitted to the tank 2. The significant resistance and the significant robustness thereof enable it to withstand this force without damage or deformation. The force of the impact is then transmitted to the side bars 11A, 11B which extend further toward the front of the tank 2. The tank 2 therefore acts as an intermediate component between the impact absorption device 30 and the side bars 11A, 11B. In other words, the impact absorption device 30 is connected to the side bars via the tank 2.

The impact absorption device 30 comprises a rear impact cross-member 31, an assembly of columns 32 which are intended to become deformed in the event of an impact, and a support 33 which is intended to be fixed directly against the tank 2. The rear impact cross-member 31 is fixed to the tank via the columns 32 and the support 33. The columns may be said to have “programmed deformation”, that is to say that they may be configured to deform in a predictable manner in the event of an impact against the rear impact cross-member 31 in order to optimize the quantity of energy absorbed by the deformation and/or in order to effectively control the deformation modes of the impact absorption device 30. To this end, the columns may comprise points of weakness such as openings or notches. The rear impact cross-member 31 may extend at least roughly parallel with the transverse axis Y, at the rear of the tank 2. The columns may extend parallel with the longitudinal axis X between the rear impact cross-member 31 and the rear wall 7B of the tank. The columns 32 thus comprise a first end which is fixed, for example welded, to the support 33 and a second end which is fixed, for example welded, to the rear impact cross-member 31. The columns may comprise a cross section which is square, rectangular or of any other form.

According to one variant, the columns 32 could also extend obliquely relative to the longitudinal axis X. The axis along which the columns extend could, for example, form an angle between 0° and 30° with the longitudinal axis X or even an angle between 0° and 45°.

According to one embodiment, the rear impact cross-member 31 could be fixed to the support 33 by means of a single column 32. This single column would preferably be positioned at the center of the impact absorption device 30. Preferably, the rear impact cross-member 31 is fixed to the support 33 by means of at least two columns 32 or at least three columns 32 or even at least four columns 32. These columns 32 may be distributed over the width of the tank 2, along the transverse axis Y. FIG. 2 illustrates an impact absorption device which comprises two columns 32, whilst FIGS. 3, 4 and 5 illustrate an impact absorption device which comprises four columns 32. There may be any number of columns. Preferably, the columns are spaced apart so as not to interfere with each other when they become deformed following an impact.

Since the tank 2 provides a wide rear wall 7B, a large surface is available for fixing the impact absorption device 30. It is thus easier to increase the number of columns which support the rear impact cross-member 31, which increases the energy absorption capacity of the impact absorption device 30. The invention thus enables a significant gain with respect to vehicles which are provided with a rear impact cross-member 31 which is fixed to the side bars of the vehicle. This is because, in such vehicles, only two columns facing each side bar are provided, which reduces the energy absorption capacity.

According to one embodiment, a honeycomb structure could be provided between the rear wall 7B of the tank and the rear impact cross-member 31 in place of or in addition to the columns 32.

Since the cross-member may be supported by greater numbers of columns and/or by a honeycomb structure, the design of the rear impact cross-member 31 may be simplified. The rear impact cross-member 31 may, for example, comprise a simple rectilinear form parallel with the transverse axis Y, that is to say a non-curved shape. The cross section of the rear impact cross-member 31 may, for example, be U-shaped. A cross-member in the form of a circular arc centered about an axis parallel with the vertical axis Z is nonetheless also possible.

The support 33 may comprise a main plate 34 which extends parallel with the transverse axis Y and the vertical axis Z. This main plate 34 is fixed to the rear wall 7B of the tank, in particular screwed using a set of fixing screws which extend through holes provided in this plate. Since the main plate 34 is supported by the rear wall 7B, the main plate 34 may be relatively thin. The main plate 34 may, for example, have a thickness less than or equal to 2 mm. The main plate is not intended to further stiffen the tank. It may serve only to distribute the pressure applied by the columns over a greater surface in the event of an impact. It is therefore not a cross-member of the chassis.

The support 33 may also comprise auxiliary plates 35 perpendicular to the main plate 34. According to the embodiment set out, the auxiliary plates 35 extend parallel with the longitudinal axis X and the vertical axis Z and are fixed to the side walls 8A and 8B of the tank, respectively, in particular by means of fixing screws. The fixing of the impact absorption device 30 by the lateral plates 35 in addition to the fixing by the main plate 34 improves the resistance of the impact absorption device.

According to one variant, the support 33 could comprise only one single auxiliary plate. According to another variant, the support 33 could comprise an auxiliary plate which extends parallel with the longitudinal axis X and the transverse axis Y and which is fixed to the upper wall 9A. The support 33 could also comprise an auxiliary plate which extends parallel with the longitudinal axis X and the transverse axis Y and which is fixed to the lower wall 9B.

In the event of an impact at the rear of the vehicle, the columns 32 become deformed and absorb the energy of the impact. In particular, the columns 32 become compressed between the cross-member 31 and the main plate 34, which abuts against the rear wall of the tank. The shock wave is transmitted to the side bars 11A, 11B by means of the tank 2. The tank comprises a non-deformable or virtually non-deformable structure 6. Thus, it transmits the whole of the loads received to the side bars 11A, 11B. If the impact is moderate, only the columns are deformed. The repair operations for the vehicle are particularly simple because it is simply necessary to unscrew the impact absorption device 30 of the tank 2 and to replace it with a new impact absorption device 30.

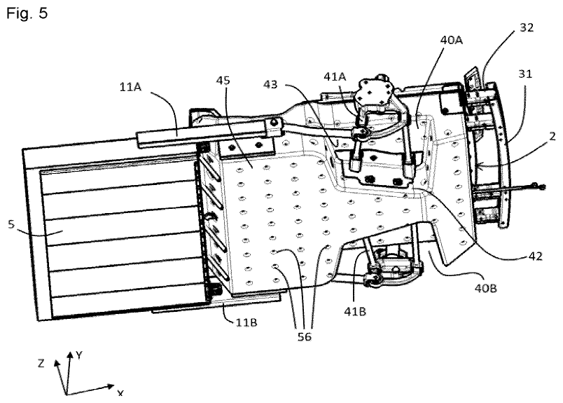

FIG. 5 illustrates the chassis 10 of the vehicle as a bottom view. It may be observed that the tank 2 may comprise two cavities 40A, 40B which are intended to receive elements 41A, 41B of a wheel set of the vehicle 1. These cavities 40A, 40B are downwardly open and each toward a lateral side of the tank. They can be delimited by an assembly of vertical walls 42 and a horizontal wall 43 which extends half-way up the tank. By arranging the cavities 40A, 40B in the tank 2, the lower wall 9B of the tank can be particularly close to the ground outside these cavities. The lower wall 9B thus comprises a zone 45 (substantially H-shaped according to the embodiment set out in FIG. 5) which extends horizontally lower than the elements 41A, 41B of the wheel set. It is thus possible to increase the capacity of the tank and to lower the center of gravity of the vehicle, which improves its stability.

Advantageously, the vehicle 1 does not comprise any carrier structure for supporting the tank 2 from below. As a result of its great resistance, the tank 2 can be exposed to impacts which occur under the underside of the vehicle, for example, an impact produced by a stone being thrown up or an impact caused by a sidewalk being crossed. Nevertheless, as will be set out below, it is possible to make provision for fixing a protection casing under the tank 2 so as to provide additional protection.

Advantageously, and as illustrated in FIGS. 6 and 7, the vehicle therefore comprises a protection casing 44 which is fixed to the tank 2. The protection casing 44 extends horizontally under the tank 2. It can be fixed directly to the tank 2 without any intermediate piece. The protection casing 44 has an upper face which is opposite the lower wall 9B of the tank and a lower wall which is exposed to the projections originating from the road. Thus, the lower wall 9B is protected from the impacts caused by stones being thrown up or when sidewalks are being crossed

Advantageously, the protection casing 44 closes the cavities 40A, 40B from below. In other words, the cavities 40A, 40B are delimited from below by portions of the protection casing 44. The protection casing 44 thus allows the elements 41A, 41B of the wheel set to be protected.

The protection casing 44 is preferably a monobloc element, that is to say it is made in one piece. The protection casing 44 thus provides better protection against the projections of water in comparison with the protection casing formed by a plurality of elements which are assembled together. It may have a generally rectangular form. Preferably, the protection casing 44 extends under the whole of the lower wall of the tank 2. The protection casing 44 therefore extends over the entire width of the substructure of the vehicle along the transverse axis Y as far as a location near the wheels which are connected to the elements 41A, 41B of the wheel set of the vehicle.

The protection casing allows a vehicle with a flat bottom to be proposed. A flat bottom improves the aerodynamics of the vehicle and reduces the risk of foreign bodies with respect to the vehicle becoming attached to the lower face of the protection casing.

The protection casing 44 may be made of plastics material, metal or any other material. It may comprise several materials, in particular in order to improve its acoustic insulation performance levels.

According to one embodiment, the protection casing 44 may comprise a deflector 46 which is configured to generate a ground effect by air circulation. The ground effect is an aerodynamic effect which is intended to press the vehicle against the ground and which therefore allows its grip with respect to the ground to be improved. The deflector 46 may comprise a slightly inclined surface relative to the longitudinal axis X. This inclined surface can extend backward and upward in the rear portion of the protection casing 44. Alternatively or additionally, the protection casing 44 and in particular the deflector 46 can also comprise fins which project downward and which extend in a plane parallel with the longitudinal axis X and the vertical axis Z. Such fins improve the lateral stability of the vehicle.

The protection casing 44 may be exclusively fixed to the tank. Alternatively, the vehicle may comprise a rear fender element which is positioned to the rear of the protection casing 44. The protection casing 44 can be fixed to this rear fender element. An overlap between the rear fender element and the protection casing may be provided in order to improve protection.

Advantageously, the vehicle 1 may also comprise an acoustic filtration element which is interposed between the protection casing 44 and the lower wall 9B of the tank. The acoustic filtration element allows the sound insulation of the passenger compartment to be improved, which is particularly advantageous when the vehicle comprises an electric motive power unit since such a motive power unit is very quiet during operation. The acoustic filtration element may, for example, comprise a layer of felt and/or foam.

With reference to FIG. 5, it may also be observed that the electrochemical battery 5 extends to the front of the tank 2 along the longitudinal axis X. The electrochemical battery 5 extends particularly between the two side bars 11A, 11B and is fixed to the two side bars 11A, 11B. The electrochemical battery 5 comprises a lower wall which is directed toward the ground. The vehicle may comprise a second protection casing (not illustrated) which is configured to protect the lower wall of the electrochemical battery. The protection casing 44 can be fixed to the second protection casing. An overlap between the protection casing 44 and the second protection casing can also be provided in order to improve protection.

Advantageously, the structure 6 of the tank 2 is made of composite material. Such a material is lighter than steel and even lighter than any other metal for equivalent resistance. Furthermore, the methods for manufacturing a component from composite material allow the production of structures 6 with a great diversity of geometric shapes. Structural shapes 6 which are more complex than those obtained from metal can thus be envisaged so as to exploit all the volume available in the vehicle and thus to increase the capacity of the tank. More complex shapes of the tank may particularly be recommended when the tanks are intended to store a pressurized gas rather than a liquid because, unlike a liquid, the gas does not pose any risk of retention in the tank.

The composite material can comprise a draped or preformed structure and/or materials which are woven and impregnated with resin. The composite material may be constituted on the basis of reinforcement elements and a matrix. The reinforcement elements may comprise carbon or glass fibers which are light materials, or Kevlar (registered mark) which has a greater resistance to impacts. The matrix may be an organic matrix, for example, epoxy resin, phenol resin or a modified polyester. The matrix may also be a metal matrix.

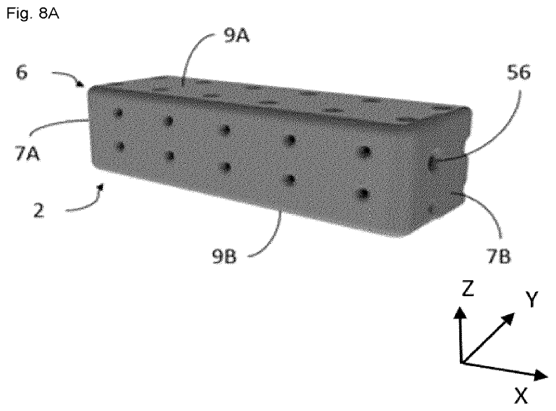

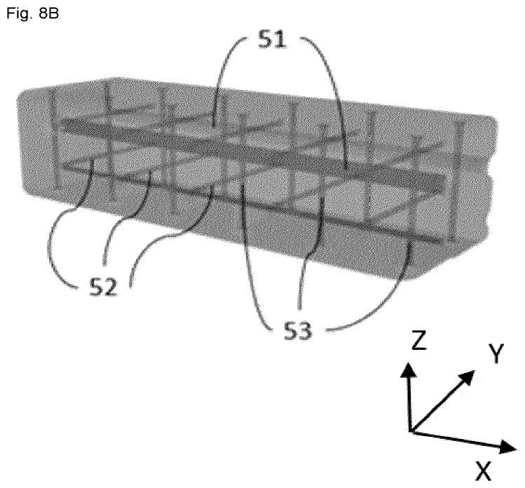

FIGS. 8A and 8B illustrate a perspective view of the structure 6 of an embodiment of the tank 2. The walls 7A and 7B are connected to each other by a first assembly of connection elements 51 which extend parallel with the axis X. Similarly, the walls 8A and 8B are connected to each other by a second assembly of connection elements 52 which extend parallel with the axis Y and the walls 9A and 9B are connected to each other by a third assembly of connection elements 53 which extend parallel with the axis Z.

According to one variant, the tank 2 could comprise only a single assembly of connection elements or only two assemblies of connection elements among the three assemblies of connection elements 51, 52, 53. In a variant, all or some of the assemblies of connection elements 51, 52, 53 could extend in different directions from the axes X, Y and Z, provided that the axis along which each of the assemblies of connection elements extends forms a non-zero angle with the axis along which the other assemblies of connection elements extend. Advantageously, the three axes along which the three assemblies of connection elements 51, 52 and 53 extend are perpendicular to each other so as to stiffen the tank in an optimum manner.

The connection elements 51, 52, 53 extend through the tank 2 at either side between two opposite walls. The connection elements act as tie rods which reinforce the resistance of the tank: they are urged in terms of traction when the energy fluid which is contained in the tank applies a pressure to the walls 7A, 7B, 8A, 8B, 9A and 9B. The connection elements 51, 52, 53 are arranged inside the envelope of the tank 2 and not at the periphery of this envelope.

Preferably, each connection element is separate from the other connection elements, that is to say that the connection elements are contactless with respect to each other and do not touch each other inside the tank. Thus, the tank 2 is not compartmentalized and the energy fluid can readily circulate inside the tank 2.

The connection elements 51, 52, 53 are hollow. In particular, the connection elements which could also be referred to as “reinforcement wells”, may be tubes when they have a circular cross section. However, the cross section of the connection elements is not necessarily circular. For example, the cross section of the connection elements could also be square, rectangular, polygonal or ovoid.

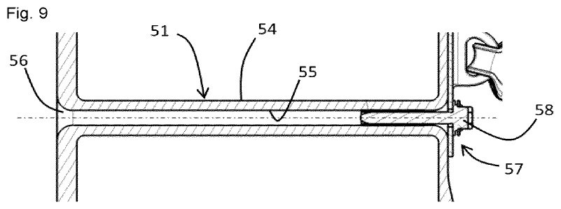

FIG. 9 illustrates in greater detail a connection element 51, the other connection elements being configured similarly. Each connection element 51, 52, 53 comprises a tubular form which is provided with an external face 54 and an internal face 55. The external face 54 is directed toward the interior of the tank and is therefore intended to be in contact with the energy fluid while the internal face 55 communicates with the exterior of the tank and is therefore intended to be in contact with ambient air.

The connection elements 51, 52, 53 can be constituted by composite material or metal. They can also comprise at the same time a composite material and metal. They may particularly comprise a metal tube which is arranged inside a structure made of composite material.

The internal face 55 can be provided with a material different from the one forming the structure 6 of the tank. The internal face 55 may particularly be fitted with a metal tube which extends over the entire length of the connection element 51, 52, 53 or only in the region of the ends of the connection elements 51, 52, 53. The metal tube may where applicable be annealed over the external periphery so as to ensure good maintenance in the structure 6.

Each connection element 51, 52, 53 comprises two opposite ends in the region of the two opposite walls which it connects. As a result of the hollow nature of the connection elements, the tank comprises, for each connection element, an opening 56 which passes completely through the tank. These openings 56 do not communicate with the storage volume of energy fluid. These openings 56 are therefore not useful for supplying an energy fluid, in particular for supplying pressurized hydrogen to the fuel cell 3.

On the other hand, the openings 56 can be used for the introduction of electrical wires and/or hydraulic conduits. Thus, it is possible to save space provided outside the tank for introducing these electrical wires and/or these hydraulic conduits while providing them with a way of fixing them in position.

The openings 56 can also be used to allow the discharge of a liquid out of the vehicle or even to produce ventilation members intended to cool or heat the passenger compartment.

Advantageously and as explained below, the openings 56 can be used to fix different equipment items of the vehicle. In particular, the openings 56 are used to fix the seats 12, the anchoring means 21, 22 of the safety devices, the car body frame 28, the impact absorption device 30, the elements 41A, 41B of the wheel sets and the protection casing 44, as described above.

To this end, the tank 2 comprises a group of fixing interfaces 57, each one being arranged at one end of at least one connection element 51, 52, 53, in particular arranged in an end of an opening 56. As illustrated in FIG. 9, all or some of the fixing interfaces 57 can comprise an insert which is intended to cooperate with a fixing screw 58, for example, a fixing screw of the M8 or M10 type. The insert can be formed in the metal tube which is fitted to the internal face 55 of the connection elements or can be an additional element which is fitted against the internal face 55 of the connection elements, for example, a plastics pin. The insert may, for example, comprise a length between 20 mm and 60 mm inclusive. The insert may be tapped or non-tapped. The insert thus provides a fixing means which extends deeply into the volume of the tank. Such a fixing means is particularly robust and allows the fixing of great loads to be envisaged.

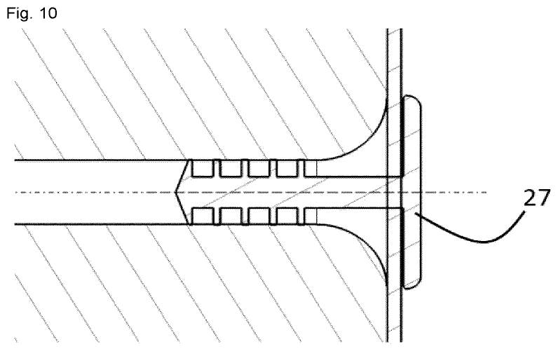

As illustrated in FIG. 10, all or some of the fixing interfaces 57 may comprise an insert which is intended to cooperate with a clip 59. The clip 59 may comprise radial fins which interfere with the tubular insert and can be fitted using force in this insert. In a variant, the clip 59 could comprise any other form. It could, for example, be intended to be fitted using force and to be unscrewed in order to be removed. Additionally, adhesive or mastic can be applied in an opening 56 in order to improve the resistance of the fixing screw 58 or the clip 59. The use of clips 59 may be preferred to the use of fixing screws in order to fix equipment items having a moderate mass and other than safety items, for example, in order to fix the protection casing 44.

Each fixing interface 57 allows an equipment item of the vehicle to be fixed against a wall of the tank. A fixing interface 57 can be arranged at the end of the opening 56 located at the side of the wall against which the equipment item is fixed. Alternatively, a fixing interface 57 could also be arranged at the end of the opening 56 located at the opposite side of the wall, against which the equipment item is fixed. In this case, an axle or cable which connects the fixing interface 57 to the equipment item could extend inside the opening 56 along it. Such an arrangement would allow, for example, the provision of the fixing interfaces in the region of the lower wall 9B in order to fix equipment items against the upper wall 9A, which would make assembly or maintenance operations of the vehicle easier.

Preferably, there are used one or more fixing interfaces which are arranged on the side walls 8A and 8B in order to fix the side bars 11A and 11B, respectively. There are used one or more fixing interfaces which are arranged on the upper wall 9A in order to fix the seat 12 and/or the anchoring means 21, 22 and/or the car body frame 28. There are used one or more fixing interfaces which are arranged on the rear wall 7B in order to fix the impact absorption device 30. There are used one or more fixing interfaces which are arranged on the lower wall 9B in order to fix the protection casing 44.

Advantageously, such fixing interfaces 57 can be provided at the ends of each opening 56 of the tank. Each connection element 51, 52, 53 can thus support two fixing interfaces 57 which are arranged on two opposite faces of the tank. The tank can thus be provided with a multiplicity of fixing interfaces 57 which allow different equipment items to be fixed in very varied positions.

The same equipment item can even be fixed to the tank 2 using two fixing interfaces or even more, so as to correctly safeguard the fixing thereof. The same equipment item can also readily be fixed at different positions of the tank without having to be modified.

The same tank 2 can also readily be re-used for different models of the vehicle because the multiplicity of fixing interfaces provides a number of possible ways of fixing the equipment items.

The openings 56 which are not intended for fixing an equipment item of the vehicle can be plugged with a closure means so as to prevent the accumulation of mud, sand, earth, stones or any other particles. In particular, the unused openings 56 can be closed with individual plugs or with a film which surrounds the whole of the tank or any other protection device. The unused openings 56 may where applicable be used during the lifetime of the vehicle, for example, to fix a new equipment item or a new accessory. In the context of a maintenance operation, it is possible to envisage an equipment item being disassembled, for example, the impact absorption device 30, and it being replaced with a new equipment item which would be fixed using fixing interfaces which were left unused up to that point.

Advantageously, the connection elements 51, 52, 53 are distributed in accordance with a regular pitch, for example, a pitch between 5 cm and 30 cm inclusive, in particular between 10 cm and 20 cm inclusive. Consequently, the fixing interfaces 57 are distributed over the walls of the tank in accordance with a regular pitch. Thus, the fixing interfaces 57 are arranged in accordance with a grid pattern at the surface of the tank 2. This further facilitates the re-use of the same tank and the same equipment item for different models of the vehicle because the same equipment item can be fixed at several locations of the tank without requiring any adaptation piece. The tank thus forms a modular structure, similarly to a Lego® brick, on which a number of equipment items can be fixed. The invention therefore allows a great freedom of design to be envisaged for motor vehicles while achieving economies of scale.

In order to manufacture the vehicle 1, it is initially possible to manufacture a chassis by assembling in particular the tank 2 on the side bars 11A, 11B. Subsequently, it is possible to fix different equipment items of the vehicle to the tank 2. In particular, there are fixed to the tank 2 the seats 12, the anchoring means 21, 22 of the safety devices, the car body frame 28, the impact absorption device 30, the elements 41A, 41B of the wheel sets and the protection casing 44, as described above, by means of the fixing interfaces 57. Therefore, the assembly of the tank is carried out before the fixing of these different equipment items in the manufacturing method for the vehicle. The fixing of these different equipment items can be carried out simply by screwing the fixing screws 58 or by fitting the clips 59. The maintenance operations which require the disassembly of these equipment items are also made easier.

Finally, as a result of the invention, there is the advantageous benefit of a vehicle which is provided with a tank for an energy fluid which is lighter because a portion of the metal chassis, with which vehicles are conventionally provided, is saved. The vehicle also provides more space for the passengers or for storage because the tank takes up some of the volume previously occupied by the chassis. Alternatively, this available volume can also be exploited to increase the size of the tank and therefore to provide a vehicle with greater autonomy. Finally, the tank provides a particularly practical support for fixing a great variety of equipment items which are mounted on-board the vehicle.

1-10. (canceled)

11. A tank for a vehicle, wherein the tank is configured to store an energy fluid, and the tank forms a structural element of the vehicle.

12. The tank as claimed in claim 11, further comprising:
a first pair of opposite walls which are connected to each other by a first assembly of hollow connection elements which pass through the tank and which extend parallel with a first axis.

13. The tank as claimed in claim 12, further comprising:
a second pair of opposite walls which are connected to each other by a second assembly of hollow connection elements which pass through the tank and which extend parallel with a second axis, the second axis forming an angle which is not equal to zero with the first axis; and
a third pair of opposite walls which are connected to each other by a third assembly of hollow connection elements which pass through the tank and which extend parallel with a third axis, the third axis forming with the first axis an angle which is not equal to zero and the third axis forming with the second axis an angle which is not equal to zero.

14. The tank as claimed in claim 13, further comprising:
at least one fixing interface which is arranged at one end of at least one of the connection elements.

15. The tank as claimed in claim 14, wherein the at least one fixing interface comprises a tapped insert which is configured to cooperate with a fixing screw and/or an insert which is intended to cooperate with a clip.

16. The tank as claimed in claim 11, further comprising:
a rigid structure which is made of composite material.

17. The tank as claimed in claim 11, wherein the tank is configured to store the energy fluid at a pressure which is greater than or equal to 700 bar.

18. The tank as claimed in claim 11, wherein the energy fluid is hydrogen.

19. A chassis for a motor vehicle, comprising:
the tank as claimed in claim 11.

20. The chassis as claimed in claim 19, further comprising:
two side bars which extend longitudinally,
wherein the tank is fixed to each of the two side bars, in a longitudinal continuation of the two side bars.

21. A motor vehicle, comprising:
the tank as claimed in claim 11.

22. A motor vehicle, comprising:
the chassis as claimed in claim 19.
